(19) United States
(12) Patent Application Publication
(10) Pub. No.: US 2015/0305250 A1
(43) Pub. Date: Oct. 29, 2015

(54) Methods and Systems for Increasing Soybean Yields

(71) Applicant: Des Moines Area Community College, Ankeny, IA (US)

(72) Inventors: Daniel Wilson, Adel, IA (US); Michael Hassis, Grimes, IA (US)

(21) Appl. No.: 14/670,977

(22) Filed: Mar. 27, 2015

Related U.S. Application Data
(60) Provisional application No. 61/971,113, filed on Mar. 27, 2014.

(51) Int. Cl. A01G 3/00; A01N 43/56; A01G 1/00; A01N 43/88; A01N 43/36; A01N 57/20; A01N 47/20; A01N 37/34

(52) U.S. Cl. CPC A01G 3/00; A01N 47/20; A01N 43/56; A01N 37/34; A01N 43/88; A01N 43/36; A01N 57/20; A01G 1/001

(57) ABSTRACT

A method of increasing yield of a soybean plant comprising, assessing a growth phase of a plant, selecting a plant if the plant is in a vegetative growth phase, removing the apical dominance of the selected plant. In further aspects, disclosed is an apparatus for removing the apical dominance of a soybean plant during vegetative stage comprising, a frame, at least two wheels mounted on the frame, and an apical dominance removal means mounted on the frame.

### CROSS-REFERENCE TO RELATED APPLICATION(S)

This application claims priority to U.S. Provisional Application No. 61/971,113, filed Mar. 27, 2014, which is hereby incorporated by reference in its entirety.

### FIELD OF THE INVENTION

The present invention relates to methods of planting and cultivating soybeans.

### BACKGROUND OF THE INVENTION

The present invention relates to methods and systems for increasing yields of a soybean plant. Soybean (Glycine max) is an important and valuable field crop. Soybean yields have increased in small increments over the past 50+ years (Irwin and Good, 2012; USDA, Economic Research Service, 2012), with slight deviations mostly driven by yearly weather variation. However, soybean yields have not kept pace with the yield increases of other crops including corn (Zea mays L.). There seems to be a yield barrier. Historically, soybeans have been planted in rows and row widths have decreased over time, but yields have not increased greatly.

There is a need in the art for methods and systems of cultivating soybeans to increase soybean yield.

### BRIEF SUMMARY OF THE INVENTION

Disclosed herein are methods of increasing the yield of a soybean plant comprising removing the apical dominance of the soybean plant during the vegetative growth phase. In certain implementations of the disclosed method, removal of the apical dominance results in an increase of lateral branching of the soybean plant.

Disclosed herein is an apparatus for removing the apical dominance of a soybean plant during vegetative stage comprising: a frame; at least two wheels mounted on the frame; and an apical dominance removal means mounted on the frame.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 shows soybean yield data.

FIG. 2 shows soybean yield data.

FIG. 3 shows soybean yield data.

FIG. 4 shows soybean yield data.

FIG. 5 shows representative images of soybean produced by conventional means compared with the disclosed method.

FIG. 6 shows representative images of soybean produced by conventional means and the disclosed method.

FIG. 7A shows a front view of a prototype of the apparatus according to certain embodiments.

FIG. 7B shows a side view of the prototype of the apparatus according to FIG. 7A.

FIG. 7C shows a side view of certain components of the prototype of the apparatus according to FIG. 7A.

FIG. 8A shows a side view of another prototype of an apparatus according to certain embodiments.

FIG. 8B shows a rear view of the prototype of the apparatus according to FIG. 8A.

FIG. 8C shows an upper perspective view of the prototype of the apparatus according to FIG. 8A.

FIG. 8D shows a close-up side view of the prototype of the apparatus according to FIG. 8A.

FIG. 9A shows a front perspective view of another prototype of an apparatus according to certain embodiments.

FIG. 9B shows a top view of the prototype of the apparatus according to FIG. 9A.

FIG. 9C shows side view of the prototype of the apparatus according to FIG. 9A.

### DETAILED DESCRIPTION

Soybean (Glycine max) is a photoperiodic plant that is widely grown for its bean, which has a large number of uses. The typical phenology of full-season soybean begins with an extended period of vegetative growth. The vegetative stages begin with unifoliate stage (V0) and continue with V1, V2, V3, V4, etc., as each new trifoliate leaf is expanded, so that a V2 plant has an expanded V2 trifoliate leaf, a V3 plant has an expanded V3 trifoliate leaf, and so on. With a typical planting date of May 1st in North America, the vegetative period of soybean growth lasts from 55-65 days. The reproductive phase, referred to as R1, begins with the presence of a flower at any node on the plant, which occurs in mid July for most adapted soybean maturities grown in a North American field environment. Reproductive development continues through 50% flowering, end of flowering, seed filling, and seed ripening.

As used herein, a “V” or a “V stage” refers to a vegetative stage of growth in a plant. For example, as used herein, “Ve” or the “Ve stage” refers to the emergence of a plant from the surface of the soil; “V1” or the “V1 stage” is when the first set of trifoliate leaves are unfolded; “V2” or the “V2 stage” is when the first trifoliate leaf is fully expanded in a plant; “V3” or the “V3 stage” is when the second trifoliate leaf is fully expanded; and “V4” or the “V4 stage” is when the third trifoliate leaf is fully expanded. A plant according to the present invention may be of any V stage, including VE, V1, V2, V3, V4, V5, or the like.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

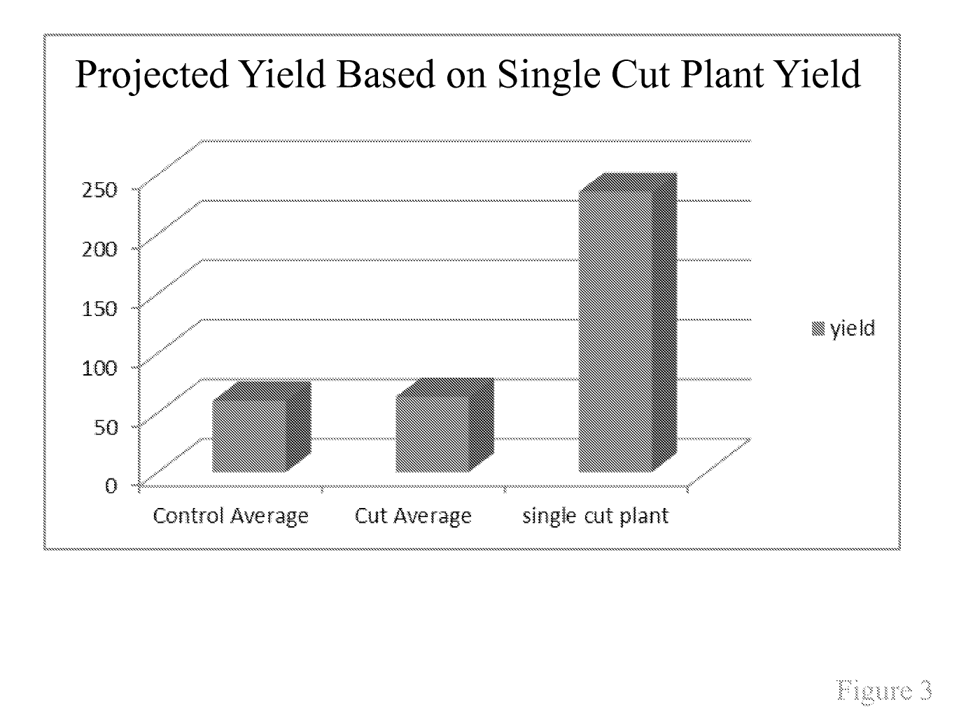

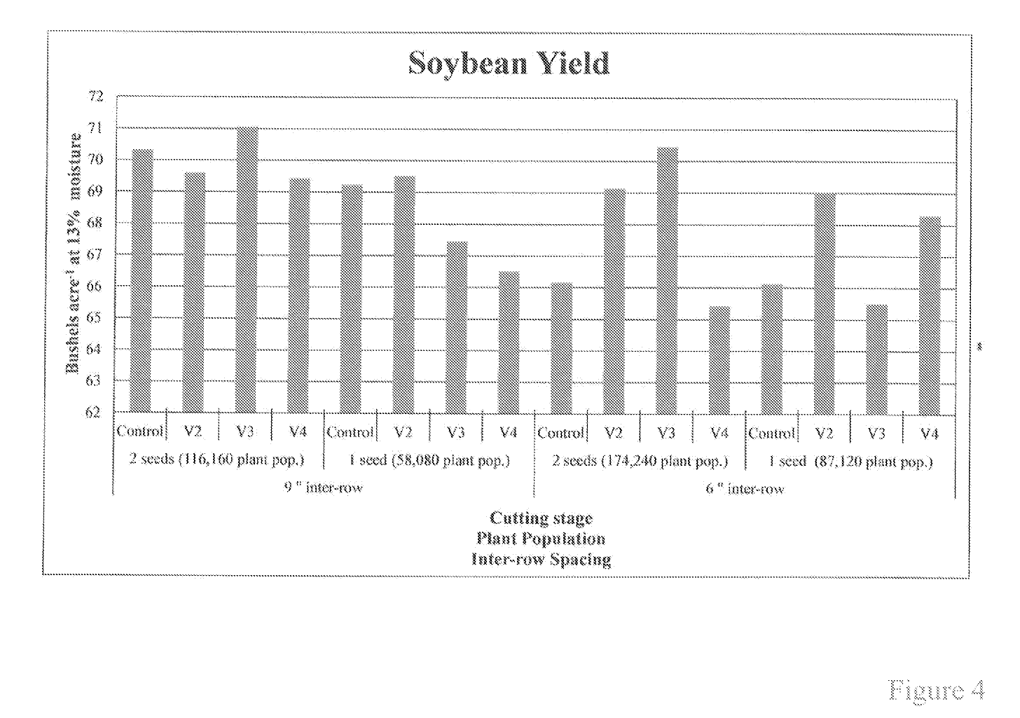

The present invention relates to a method of increasing yield of a soybean plant comprising removing the apical dominance of the soybean plant during vegetative growth phase. In certain implementations of the disclosed method, removal of the apical dominance results in an increase of lateral branching (also known as basal growth) of the soybean plant. Removal of apical dominance also increases pod cluster size, as best seen in FIGS. 4 & 5, and closer node development, each of which contribute to increased yields.

According to certain embodiments, the apical dominance is removed during the V1 growth phase. In certain embodiments, the apical dominance is removed above a first unifoliate leaf.

According to further embodiments, the apical dominance is removed at vegetative growth phase of V2 and the apical dominance is removed above the second trifoliate leaf.

According to certain implementations, the apical dominance is removed at a vegetative growth phase of V3. In yet further embodiments, the apical dominance is removed above the third trifoliate leaf during the vegetative growth phase of V3.

In still further embodiments, the timing of apical dominance removal is determined according to height of the plant. For example, according to certain embodiments, the apical dominance is removed when the plant reaches a height of between about 3 and about 6 inches. In further embodiments, apical dominance is removed when the plant reaches a height of about 3, about 4, about 5 or about 6 inches.

In yet further embodiments, the apical dominance is removed by cutting the plant a predetermined distance from the ground. In certain embodiments, the plant is cut from about 3.5 inches to about 4.5 inches from the ground.

According to further embodiments, the timing of apical dominance removal is determined according to days after emergence. For example, according to certain embodiments the apical dominance is removed between about 10 and 35 days post-emergence. In certain embodiments, apical dominance is removed In further embodiments, apical dominance is removed from about 55 to about 60 days after planting date. In further embodiments, apical dominance is removed from about 60 to about 70 days after the planting date. In certain embodiments, apical dominance is removed 60, 61, 62, 63, 64, 65, 66, 67, 68, 69, or 70 days after planting. One skilled in the art will appreciate that post-emergence timing will vary according to the growing temperature, fertility, soil type, and amount of sunlight for a given time of the year.

In certain implementations, the method further comprises removing the apical dominance of a plurality soybean plants. The plurality of plants may be planted according to a variety of densities and configurations. According to certain embodiments, plants are planted at a density between about 60,000 to about 120,000 plants per acre. In certain embodiments soybeans are planted in 30 inch rows at a density of about 100,000 plants per acre. In further embodiments, soybean plants are planted at substantially lower densities to allow for additional space for lateral branching. For example, in certain embodiments, soybean plants are planted at about a 1 foot spacing with a resulting density of about 43,000 plants per acre. In still further embodiments, plants are spaced at a 15″ by 15″ spacing with a population of 28,000 per acre. In yet further embodiments, plants are planted in 12″ rows spaced at 6″, 9″, or 12″. As will be understood by one skilled in the art, other spacing are possible.

In certain embodiments, the apical dominance is removed using a mechanized means. According to certain implementations, the apical dominance is removed by an apparatus configured to cut the plant at a specified height. In certain embodiments, the apical dominance is removed by cutting by way of a rotating a mower blade. In further embodiments, the speed of the mower blade rotation is adjusted according to the speed of travel of the apparatus to provide for an optimized cut. In still further embodiments, the apical dominance is removed by a mechanized means whereby the plant is cut, clip, sheared, plucked or laser cut. One skilled in the art will appreciate that other mechanized means of apical dominance removal are possible.

According to certain embodiments, the method further comprises providing the soybean plant a spray treatment following apical dominance removal. This spray treatment serves to protect the injured plant and boost resistance to infection at the cut site. In certain embodiments, multiple spray agents are delivered to the plant. Examples of agents that may be used include but are not limited to: Headline® (Pyraclostrobin), Stratego® (Propiconazole/Trifloxystrobin), Priaxor® (Fluxapyroxad/pyraclostrobin), Warrior II®(Lambda-cyhalothrin), Cruiser Maxx® (Thiamethoxam/Mefenoxam/Fludioxonil) and Roundup® (Glyphosate). As will appreciated by one skilled in the art, other agents can be used.

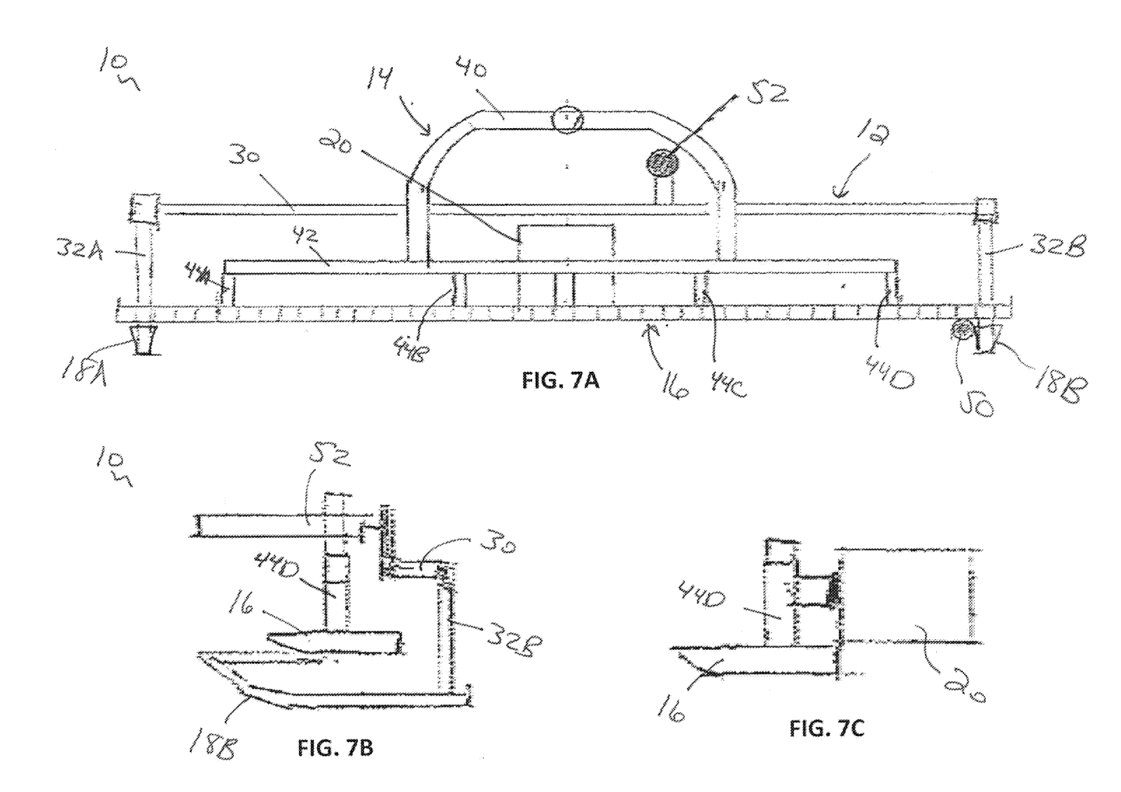

Disclosed herein are certain apparatus embodiments for removing the apical dominance of a soybean plant during vegetative stage. One implementation is an apical dominance removal device 10 as depicted in FIGS. 7A-7C. The device 10 has a base frame 12, a cutter frame 14, a cutting component 16, two skids 18A, 18B coupled at each end of the base frame 12, and a motor 20 operably coupled to the cutting component 16. The base frame 12 has a horizontal support bar 30 that has vertical support rods 32A, 32B at each end. The skids 18A, 18B are coupled to the distal ends of each support rod 32A, 32B. The cutter frame 14 has a cutter frame support bar 40 that is coupled to a horizontal cutter support bar 42 that is operably coupled to the cutting component 16 via four vertical cutter support rods 44A, 44B, 44C, 44D.

In accordance with one embodiment, the cutter frame 14 is slidable or otherwise movable in relation to the base frame 12 such that the cutting component 16 can be moved vertically to adjust to the height of the soybeans being cut. More specifically, in this specific implementation, the cutter frame support bar 40 is slidable in relation to the horizontal support bar 30 such that the cutter frame support bar can move up and down and thereby allow for vertical adjustment of the cutting component 16.

The device 10 also has a height sensor 50 and a height adjustment mechanism 52. The height sensor 50 in this embodiment is coupled to an underside portion of the cutting component 16 and is configured to detect the height of each soybean plant. The sensor 50 is operably coupled to the height adjustment mechanism 52 such that the soybean plant height information can be transmitted to the height adjustment mechanism 52 (or alternatively to a processor (not shown) operably coupled to both the sensor 50 and the height adjustment mechanism 52). The information can be used to actuate the height adjustment mechanism 52 to urge the cutter frame 14 in the desired vertical direction to adjust the height of the cutting component 16 accordingly to match the height of the soybean plant and thereby successfully cut the apical dominance of the plant.

In certain implementations, the device 10 is pushed or pulled by another vehicle or implement that is self-propelled. For example, according to certain embodiments, the base frame 12 is coupleable to the front end of a tractor, a mower, or any other appropriate self-propelled implement that can maintain and steer the device 10 through a field. Alternatively, the base frame 12 can be coupleable to the back end of such an implement.

Alternatively, the device 10 is propelled by the user. In still further embodiments, the device 10 is self-propelled. That is, the device 10 has a motor (not shown) mounted to the frame to provide propulsion of the device. In yet further embodiments, the device 10 further comprises an integration system for adjusting the speed of operation of the cutting component 16 according to the speed of travel of the device 10.

The cutting component 16 in accordance with one implementation is a sickle bar 16 having multiple moving blades that can be used to cut the apical dominance. For example, in one specific embodiment, the sickle bar 16 is a sickle bar available from Jari Mowers in Mankato, Minn. Alternatively, the cutting component 16 is any sickle type blade or component. In a further alternative, the cutting component 16 can be any known cutting component adapted to cut plants in a field setting. In certain embodiments, the cutting component 16 is comprised of one or more blades. According to certain implementations, the cutting component 16 is configured to minimize damage to the soybean plant upon cutting.

According to certain implementations, the cutting component 16 further comprises a mechanism to adjust angle of the cut. In certain embodiments, the cutting component is adapted to remove the apical dominance by cutting the plant about 3.5 to about 4.5 inches above ground. In further embodiments, the cutting component 16 operates by way of clipping the plant. In still further embodiments, the cutting component 16 operates by way of shearing the plant. In yet further embodiments, the cutting component 16 operates by way of plucking the plant. In further embodiments, the cutting component 16 operates by way of laser cutting the plant.

In one embodiment, the height adjustment mechanism 52 is a solenoid 52. Alternatively, the height adjustment mechanism 52 can be any known mechanism for urging the cutter frame 14 vertically and thereby adjust the height of the cutting component 16.

According to certain alternative embodiments, the device 10 has wheels instead of skids 18A, 18B.

The motor 20 is an electric, variable speed motor 20 that can be used to vary the speed of the cutting component 16 to match the speed that the device 10 is moving across a field of soybeans. Alternatively, the motor 20 is any known motor 20 that can be used with a cutting component such as cutting component 16.

In one embodiment, the device 10 and the cutting component 16 are wide enough to span 12 rows of soybeans such that the cutting component 16 can the apical dominance of 12 rows of soybeans at the same time. Alternatively, the device 10 and cutting component 16 are wide enough to span 18 rows. In a further alternative, the device 10 and cutting component 16 are wide enough to span 2 rows, 4 rows, 8 rows, or any number of rows.

According to certain embodiments, the device 10 can also have one or more spraying components (not shown) (also referred to as “sprayers”). The one or more sprayers are configured to deliver spray treatments aimed at reducing infection to cut plants. In further implementations, the sprayers can be configured to deliver coolant to the cutting component 16 to prevent damage to plants from the overheating of the component 16. In certain embodiments, each of the one or more sprayers further comprises a nozzle, at least one valve regulating flow of liquid through the nozzle, a liquid supply line, and a liquid storage tank mounted to the frame and connected to the nozzle by the liquid supply line.

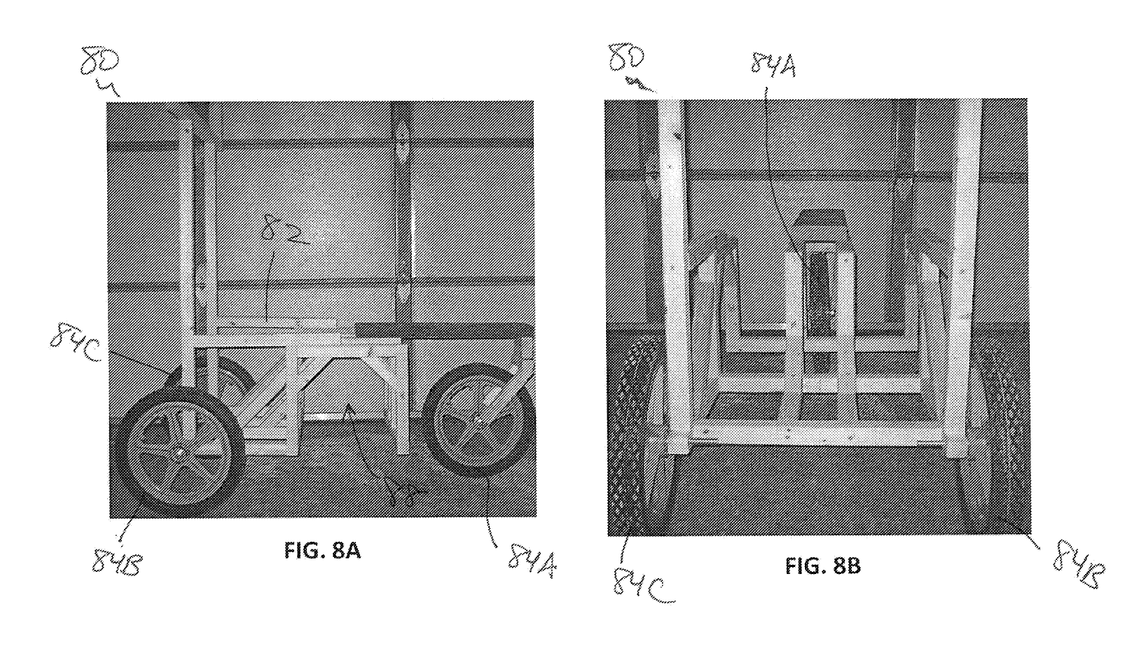

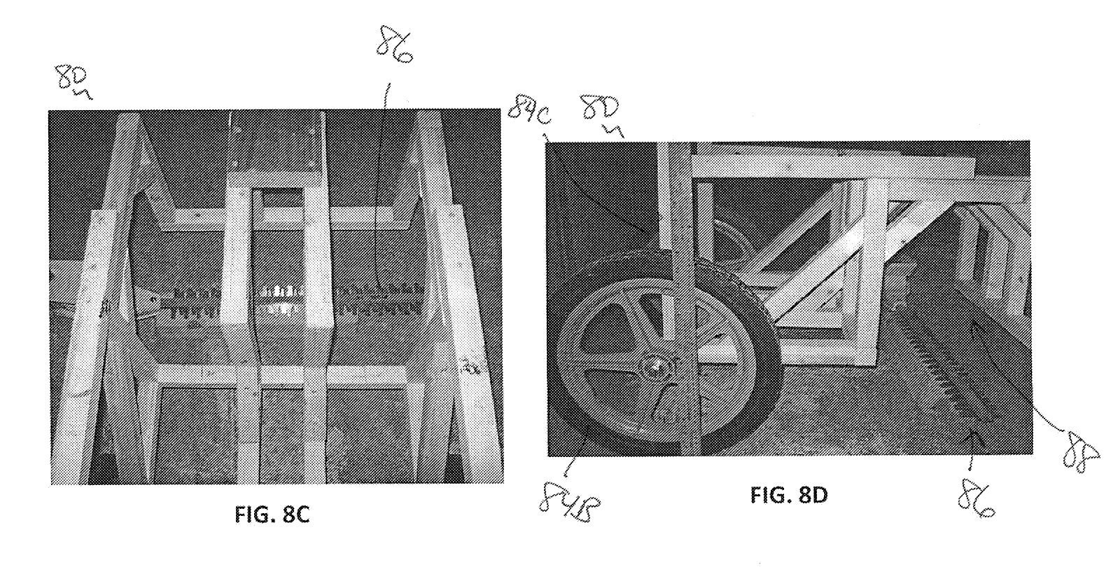

An alternative embodiment of an apical dominance removal device 80 is depicted in FIGS. 8A-8D. This device 80 has a frame 82 with three wheels 84A, 84B, 84C and a cutting component 86 operably coupled thereto. In this embodiment, the device 80 has three wheels 84A, 84B, 84C in a tricycle configuration, with two rear wheels 84B, 84C arranged on the rear of the frame and one front wheel 84A arranged on the front of the frame. Alternatively, the device 80 could also have two wheels, four wheels, or any number of wheels.

As best shown in FIGS. 8C and 8D, the frame 82 has a cutting component cavity 88 defined in the frame 82 that is configured to retain or enclose the cutting component 86 or otherwise allow the cutting component 86 to be disposed therein. According to certain implementations, the cutting component 86 comprises a dynamic height adjustment mechanism to allow the user to adjust the height of the cut according to the height of the plants about to be cut. According to certain embodiments, the dynamic height adjustment system is an electric and or hydraulic system. In still further embodiments, the apparatus further comprises a system for detecting height of plants to be cut and provides automatic adjustment of the dynamic height adjustment mechanism optimized to said height. In yet further embodiments, the dynamic height adjustment mechanism adjusts height between a height of about 3 inches and a heights of about 7 inches.

As best shown in FIG. 8B, the two rear wheels 84B, 84C according to one embodiment are adjustable to a plurality of widths to accommodate a plurality of soybean row spacings in the field. For example, in certain implementations, the wheels 84B, 84C are adjustable to accommodate 12 inch rows or 15 inch rows.

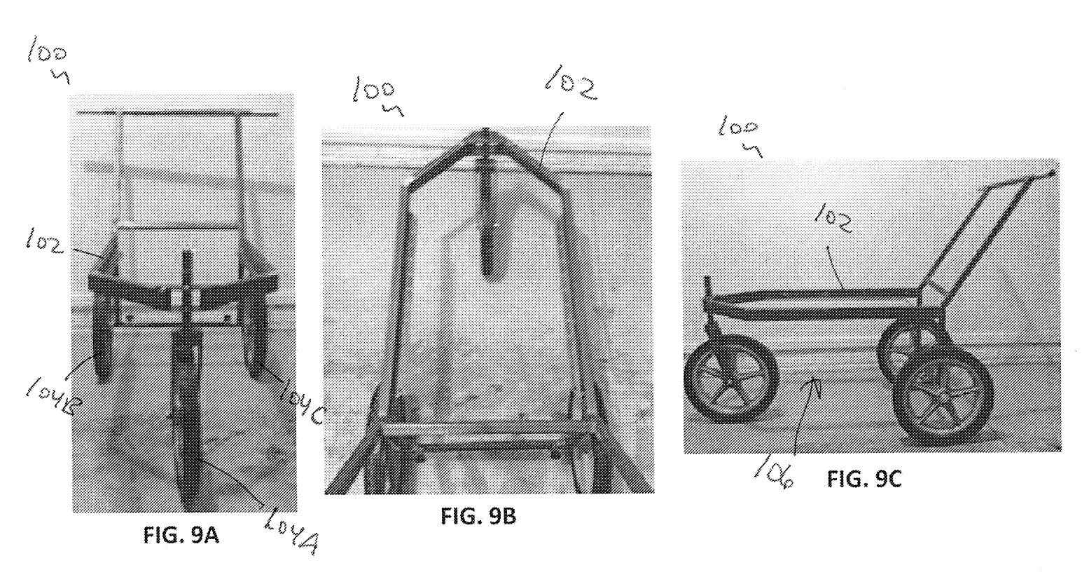

A further alternative embodiment of an apical dominance removal device 100 is depicted in FIGS. 9A-9C. This device 100 has a frame 102 with three wheels 104A, 104B, 104C and a cutting component (not shown) operably coupled thereto. As best shown in FIG. 9C, the frame 102 has a large cutting component cavity 106 defined in the frame 106 that is configured to retain or enclose the cutting component (not shown) or otherwise allow the cutting component (not shown) to be disposed therein.

It is understood that any of the components and alternative embodiments described above with respect to any of the device embodiments (such as device 10, device 80, and device 100) can also be incorporated into any of the other devices (including device 10, 80, or 100).

In certain aspects, disclosed is a method of increasing yield of a soybean plant comprising assessing a growth phase of a plant, selecting a plant if the plant is in a vegetative growth phase, removing the apical dominance of the selected plant. In further aspects, the vegetative growth phase is V2 growth phase. In still further aspects, the vegetative growth phase is V3 growth phase. In yet further aspects, the apical dominance is removed above a first unifoliate leaf. According to certain aspects, the apical dominance is removed above a first trifoliate leaf. In further aspects, the plant is between about 10 and 35 days old after emergence. In still further aspects, the plant is between about 3 and 6 inches high. In yet further aspects, the plant is cut between about 3.5 and about 4.5 inches from the ground.

According to certain aspects, the disclosed method further comprising providing the plant a disinfectant. In certain aspects, the disinfectant is selected of a group comprising Pyraclostrobin, PropiconazoleTrifloxystrobin, Fluxapyroxad, Lambda-cyhalothrin, Thiamethoxam, Mefenoxam, Fludioxonil and Glyphosate.

According to certain aspects, the at least one soybean plant further comprises a plurality of plants. In further aspects, the plurality of plants are planted at a density of about 43000 plants per acre.

In certain aspects, the apical dominance is removed by a mechanized means. In further aspects, the apical dominance removal means removes the apical dominance by means of cutting, clipping, shearing, plucking or laser cutting.

In certain aspects, disclosed is an apparatus for removing the apical dominance of a soybean plant during vegetative stage comprising a frame, at least two wheels mounted on the frame, and an apical dominance removal means mounted on the frame. In certain aspects, the apical dominance removal means is a sickle blade, said sickle blade adapted to cut at a height of between about 3 inches and about 6 inches. In certain aspects, the apparatus further comprises a motor mounted on the frame configured to drive the apical dominance removal means. In still aspects, the apparatus further comprises a third wheel mounted on the frame. In yet further aspects, two of the at least two wheels are rear wheels arranged on the rear of the frame and the third wheel is arranged on the front of the frame and wherein the rear wheels are adjustable to be configured to operate at a plurality of row widths. According to still further aspects, the apparatus further comprises a means of delivering a spray agent to the plant.

### EXAMPLES

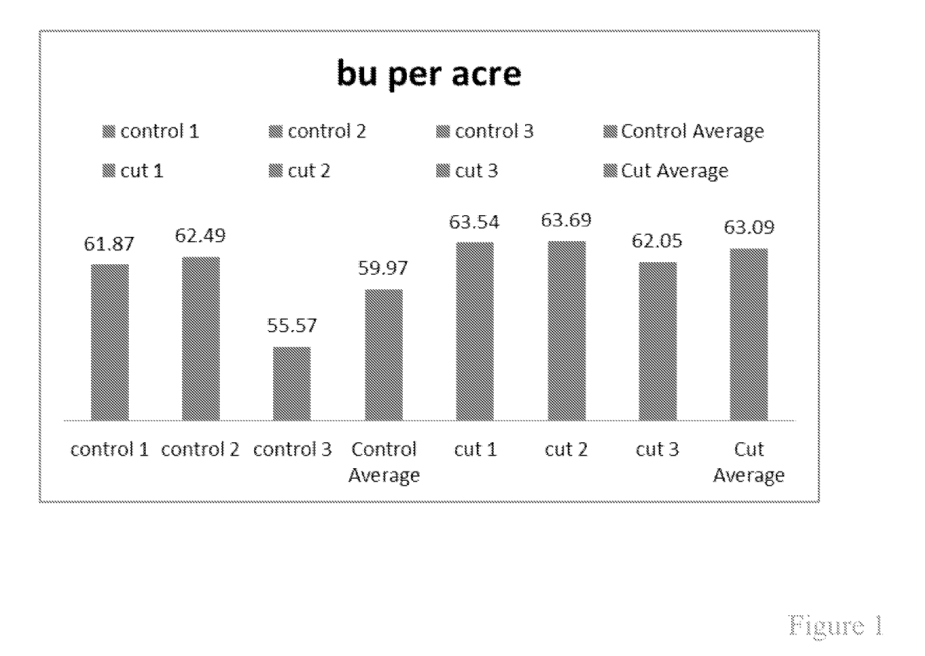

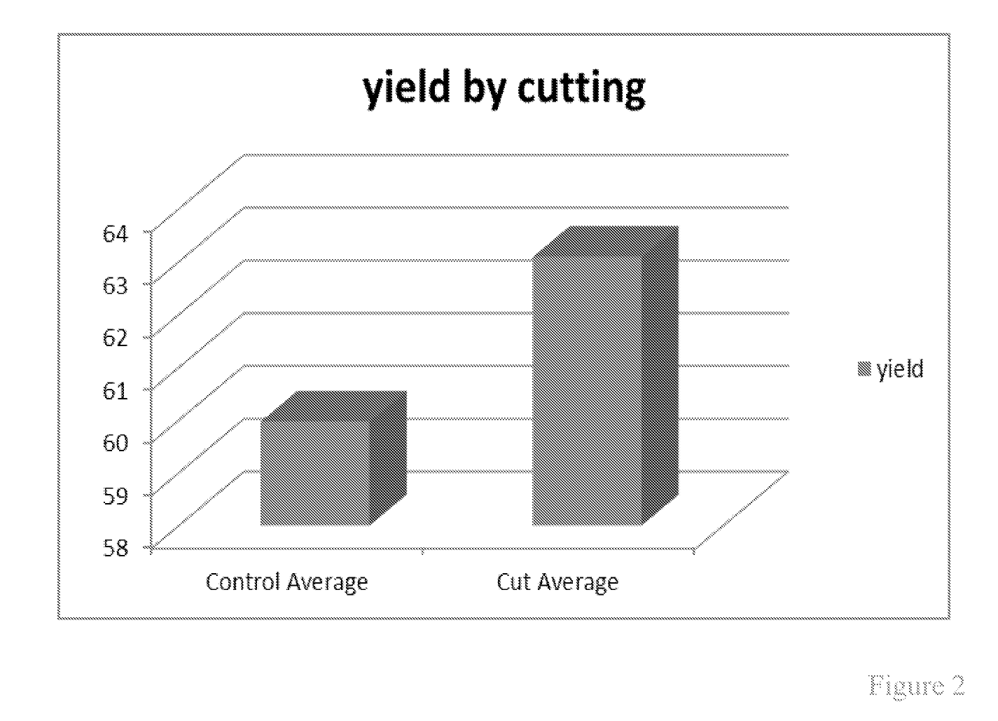

Soybeans were planted in 30 inch rows. Apical dominance was removed by hand cutting at V2, about 20 days post-emergence and at a plant height of about 4 inches. Cuts were made at approximately ½″-¾″ above the trifoliate leaf. Soybean plants were harvested from portions of 3 cut rows (apical dominance removed) and 3 adjacent control rows (apical dominance intact) with comparable soil conditions and pest management. FIG. 1 shows the data of soybean yield (bu/acre) for the three cut groups and the three control groups. Each of the cut groups had greater yield then each control group and as best seen in FIG. 2, the overall average of cut soybean yield was greater than the control yield.

Soybeans plants were also planted singly to simulate conditions of lower density planting, where there is more room for lateral branching. FIG. 3 shows an extrapolated per acre yield based on single plant yield assuming a one foot planting density. Extrapolated yields from single cut plants are approximately 235 bu/acre, a nearly fourfold increase compared to control groups.

FIG. 4 shows soybean yield data from an additional trial with apical dominance removed at the indicated vegetative growth phase compared to control plants without apical dominance removal. Plots were planted with either one or two seeds with either 6″ or 9″ row spacing. Apical dominance was removed using a mower as disclosed herein. Cut height was set according to average height of the first trifoliate leaf for V2 plants or second trifoliate leaf for V3 and V4 plants. Apical dominance removal showed significant yield increases during the V2 and V3 phases for plants in double and single 6″ and 9″ rows.

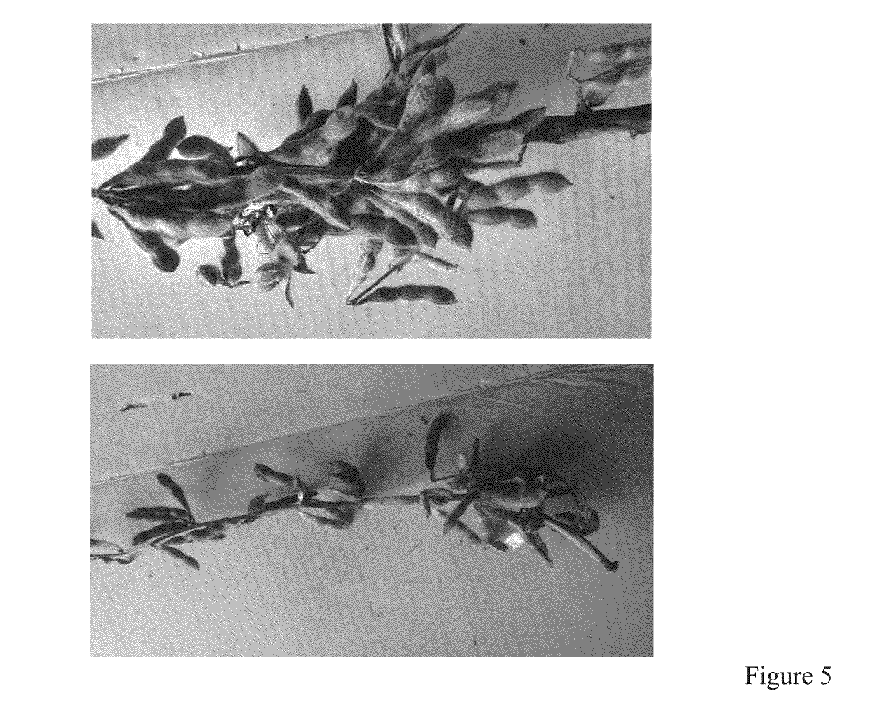

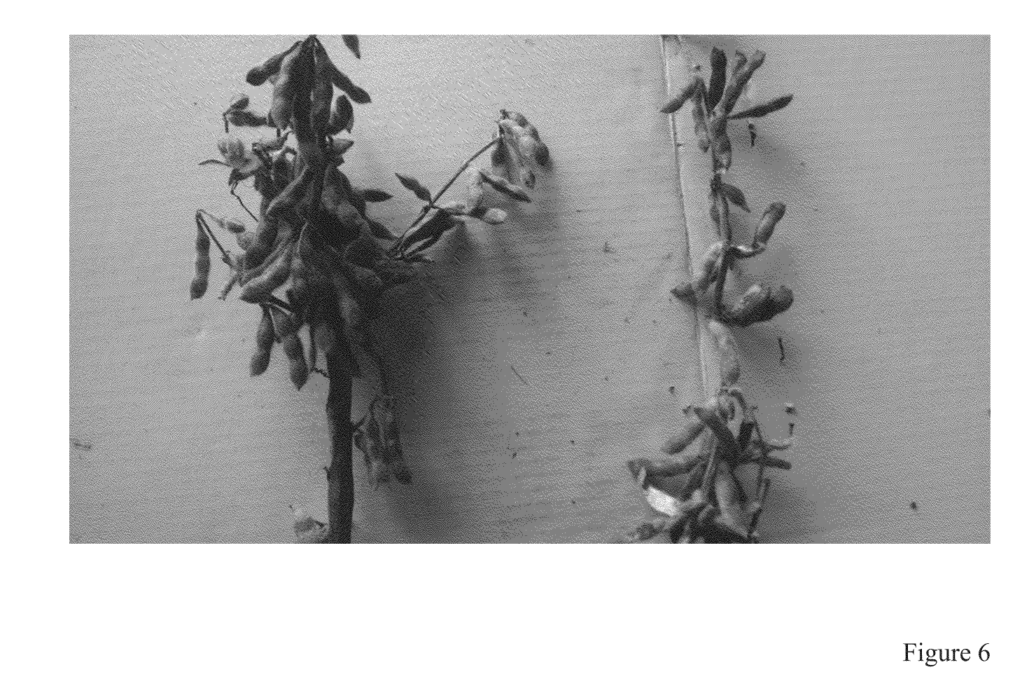

FIGS. 5 and 6 show representative plants from control conditions and cut conditions. Substantially greater pod production can be seen in both cut plants compared to controls.

Although the present invention has been described with reference to preferred embodiments, persons skilled in the art will recognize that changes may be made in form and detail without departing from the spirit and scope of the invention.

What is claimed is:

1. A method of increasing yield of a soybean plant comprising:
a. assessing a growth phase of a plant;
b. selecting a plant if the plant is in a vegetative growth phase;
c. removing the apical dominance of the selected plant.

2. The method of claim 1 wherein the vegetative growth phase is V2 growth phase.

3. The method of claim 1 wherein the vegetative growth phase is V3 growth phase.

4. The method of claim 2 wherein the apical dominance is removed above a first unifoliate leaf.

5. The method of claim 2 wherein the apical dominance is removed above a first trifoliate leaf.

6. The method of claim 1 wherein the plant is between about 10 and 35 days old after emergence.

7. The method of claim 1 wherein the plant is between about 3 and 6 inches high.

8. The method of claim 1 wherein the plant is cut between about 3.5 and about 4.5 inches from the ground.

9. The method of claim 1 further comprising providing the plant a disinfectant.

10. The method of claim 9 where in the disinfectant is selected of a group comprising Pyraclostrobin, PropiconazoleTrifloxystrobin, Fluxapyroxad, Lambda-cyhalothrin, Thiamethoxam, Mefenoxam, Fludioxonil and Glyphosate.

11. The method of claim 1 wherein the at least one soybean plant further comprises a plurality of plants.

12. The method of claim 11 wherein the plurality of plants are planted at a density of about 43000 plants per acre.

13. The method of claim 11 wherein the apical dominance is removed by a mechanized means.

14. The method of claim 13 wherein the apical dominance removal means removes the apical dominance by means of cutting, clipping, shearing, plucking or laser cutting.

15. An apparatus for removing the apical dominance of a soybean plant during vegetative stage comprising:
a. a frame;
b. at least two wheels mounted on the frame; and
c. an apical dominance removal means mounted on the frame.

16. The apparatus of claim 15, wherein the apical dominance removal means is a sickle blade, said sickle blade adapted to cut at a height of between about 3 inches and about 6 inches.

17. The apparatus of claim 15, further comprising a motor mounted on the frame configured to drive the apical dominance removal means.

18. The apparatus of claim 15, further comprising a third wheel mounted on the frame.

19. The apparatus of claim 18, wherein two of the at least two wheels are rear wheels arranged on the rear of the frame and the third wheel is arranged on the front of the frame and wherein the rear wheels are adjustable to be configured to operate at a plurality of row widths.

20. The apparatus of claim 15, further comprising a means of delivering a spray agent to the plant.
